(19) United States
(12) Patent Application Publication
(10) Pub. No.: US 2026/0041260 A1
(43) Pub. Date: Feb. 12, 2026

(54) PARTY PULLZ PROTECTORZ 1 ROW SLAB DISPLAY CASE WITH DISPLAY WINDOW

(71) Applicants: Darlene Keomorodok Ken, La Quinta, CA (US); Jason Phillip Galardi, La Quinta, CA (US)

(72) Inventors: Darlene Keomorodok Ken, La Quinta, CA (US); Jason Phillip Galardi, La Quinta, CA (US)

(21) Appl. No.: 18/797,917

(22) Filed: Aug. 8, 2024

(51) Int. Cl. A47F 7/00; A47F 5/00; E05B 37/00; E05B 65/52

(52) U.S. Cl. CPC A47F 7/0042; A47F 5/00; E05B 37/0048; E05B 65/52

(57) ABSTRACT

The Party Pullz Protectorz 1 Row PSA Slab Case is a specialized display case designed for the secure and visually appealing presentation of collectible card slabs, including those graded by PSA, SGC, and Beckett. The case features a clear acrylic window that prominently showcases up to three slabs, while its interior is lined with reinforced foam inserts to provide enhanced protection against physical damage and environmental factors. The case is equipped with programmable rolling locks to ensure security and prevent unauthorized access. Available in various colors and a modern square shape, the case offers a sleek and versatile solution for both professional and enthusiast collectors seeking to display their valuable items with style and confidence.

### FIELD OF THE INVENTION

The present invention pertains to the field of display cases, with a specific emphasis on cases designed to present and protect collectible cards, such as Professional Sports Authenticator (PSA) slabs, Sports Guaranty (SGC) slabs, and Beckett slabs. Collectible cards are often encased in slabs by grading companies to preserve their condition, which adds to their value and desirability among collectors. These slabs, while protective, require an additional layer of safeguarding and a method of display that enhances their visual appeal.

This invention addresses the dual needs of protecting and showcasing collectible cards. Traditional storage solutions for such items typically prioritize either protection or display, but not both. For instance, standard boxes or containers provide physical security but do not allow for easy viewing. At the same time, open display stands may present the cards attractively but expose them to potential damage from environmental factors such as dust, moisture, or physical contact.

The invention in question innovatively combines these elements, offering a solution that not only secures the slabs against damage but also presents them in a visually appealing manner. This is particularly important in the context of collectible markets where the presentation can significantly influence perceived value and desirability. The design features of this display case, such as the acrylic window and reinforced foam inserts, are specifically tailored to meet the needs of serious collectors who wish to display their items prominently while ensuring their protection.

### BACKGROUND OF THE INVENTION

Collectible cards, particularly those graded and encapsulated by companies like Professional Sports Authenticator (PSA), Sports Guaranty (SGC), and Beckett, are highly prized by collectors. These cards are valued not only for their rarity and historical significance but also for their condition, which is preserved and certified through the grading process. The condition of these cards can significantly impact their market value, making their protection a paramount concern for collectors.

Traditional storage solutions, such as simple boxes or binders, often fall short in providing the necessary protection and display options for these valuable items. While these methods may keep the cards organized and relatively safe from handling, they do not adequately protect against environmental hazards such as dust, moisture, and UV light. Additionally, these storage solutions do not offer a way to display the cards in a manner that highlights their visual appeal and significance, which is an important aspect for collectors who wish to showcase their collections.

Some existing display solutions, such as open stands or basic display cases, allow for the viewing of these collectible cards but often compromise on protection. These solutions may leave the cards exposed to physical damage from accidental contact or from environmental factors that can degrade the quality of the slabs and the cards within them.

The need for a comprehensive solution that combines both display and protection led to the development of the Party Pullz Protectorz-1 Row PSA Slab Case. This invention provides a secure and aesthetically pleasing way to display collectible cards. It features an acrylic window that prominently showcases the cards, allowing collectors to exhibit their most prized items. The case is also designed with reinforced foam inserts that cradle the slabs, providing robust protection against shocks, bumps, and other potential damage. The inclusion of programmable rolling locks further enhances security, offering peace of mind to collectors who invest significantly in their collections.

This invention not only addresses the shortcomings of traditional storage and display methods but also meets the growing demand for sophisticated and secure display options in the collectible card market. By offering a solution that protects the condition of the cards while enhancing their visual presentation, this display case represents a significant advancement in the field of collectible storage and display.

### SUMMARY OF THE INVENTION

The Party Pullz Protectorz 1 Row PSA Slab Case is a specialized display case designed to both showcase and protect collectible cards, particularly those encased in PSA slabs. This innovative case features an acrylic window that provides a clear and unobstructed view of the slabs, allowing collectors to prominently display their most valuable items. The design emphasizes a sleek and modern aesthetic, making it an attractive addition to any collection display setup.

Constructed with reinforced foam inserts, the case provides enhanced protection for the slabs, safeguarding them against physical damage such as bumps, scratches, and drops. This feature ensures that the collectible cards remain in pristine condition, preserving their value over time. The case also includes programmable rolling locks, offering an additional layer of security by allowing users to set a custom combination lock code, thereby preventing unauthorized access.

The Party Pullz Protectorz 1 Row PSA Slab Case is available in a variety of colors, catering to the diverse tastes of collectors and allowing them to choose a case that complements their personal style or the decor of their display space. This versatility makes the case suitable for both professional collectors, who may require multiple cases for a large collection, and enthusiast collectors, who seek a high-quality solution for displaying a smaller number of prized items.

Overall, this invention provides a comprehensive solution that addresses the dual needs of display and protection in the collectible card market. It combines visual appeal with practical functionality, offering collectors a way to both enjoy and preserve their collections.

### DETAILED DESCRIPTION OF DRAWINGS

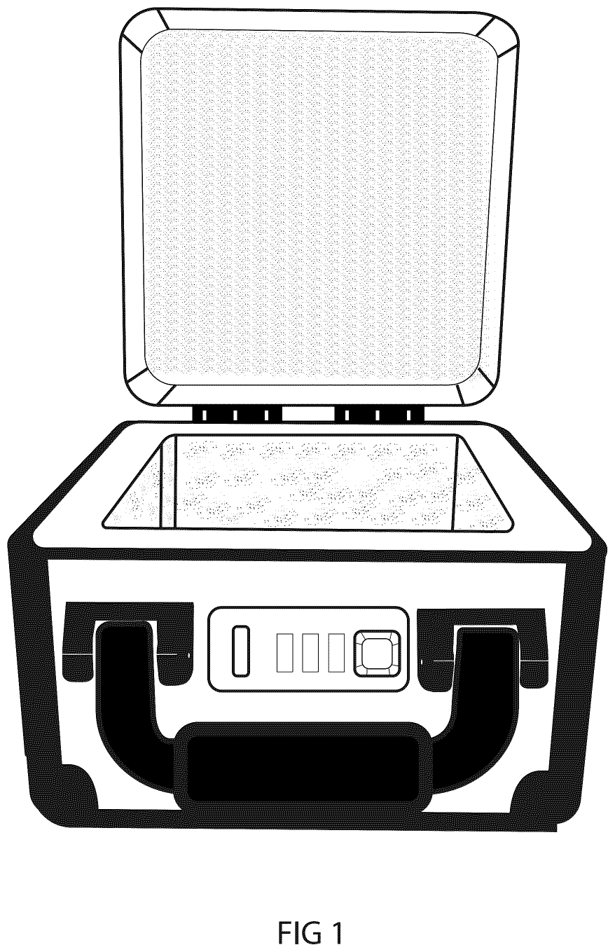

FIG. 1: Depicts the front/forward facing view with a view of the case open with the interior top foam in place (1), and the interior bottom foam that holds the graded cards. (3) is the rolling lock and clasp. (4) depicts the plastic handle.

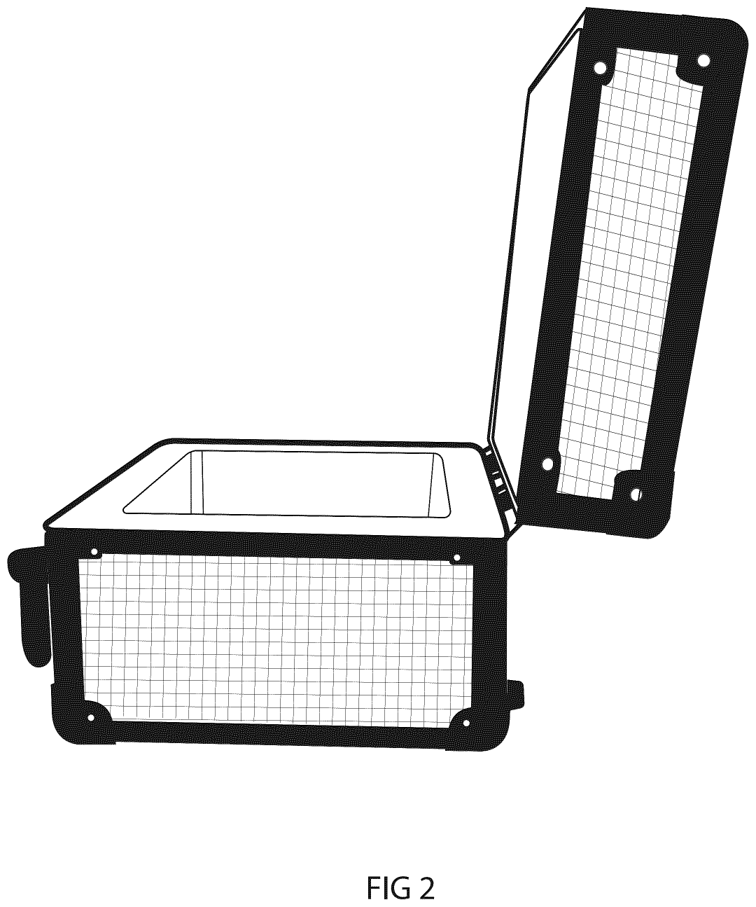

FIG. 2: Depicts the side view of the case while being open. (1) is the interior bottom foam that holds the graded cards. (2) depicts the plastic handle. (3) is the side wall of the base and lid of the case.

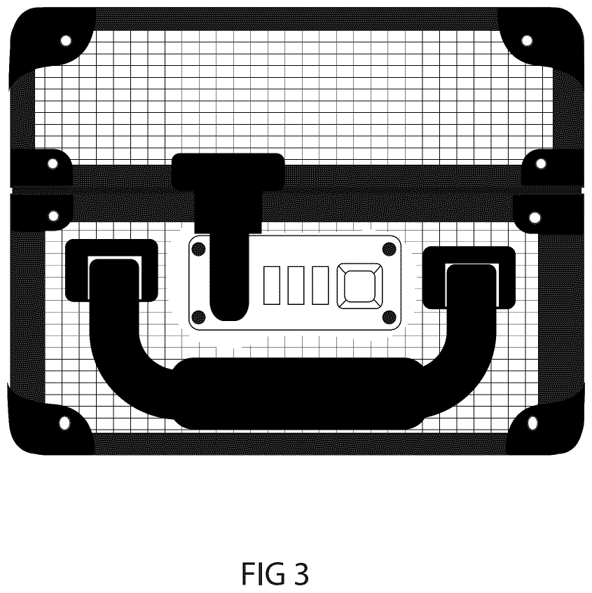

FIG. 3: Shows the case closed and locked. (1) is the rolling lock and clasp in its closed position. (2) depicts the plastic handle. (3) is the front facing part of the closed case.

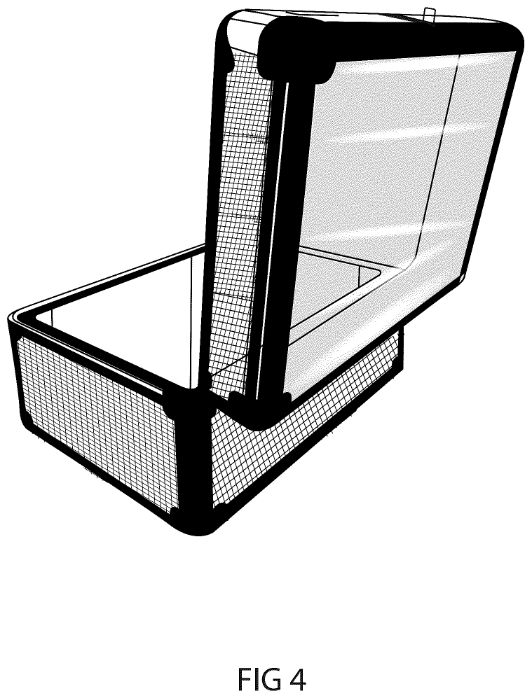

FIG. 4: Depicts the case while open. (1) Shows a clear acrylic window display with no foam insert. (2) is the interior bottom foam that holds the graded cards.

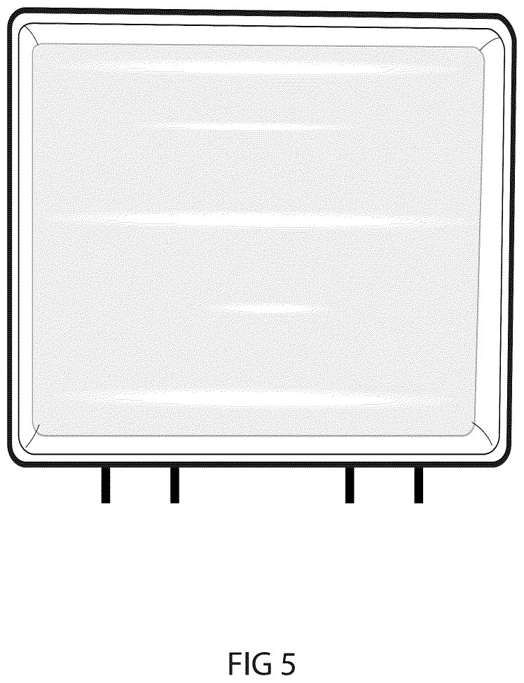

FIG. 5: Depicts the view of the top of the case looking into the (1) clear acrylic window display with no foam insert. (2) are the hinges for the lid of the case.

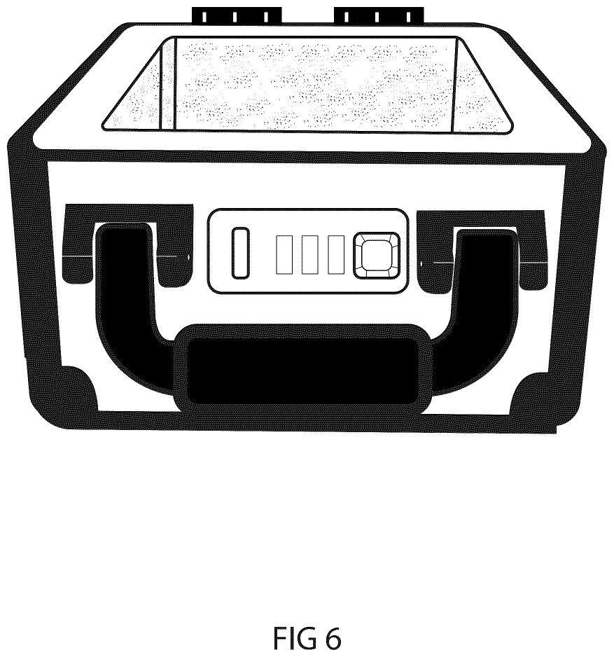

FIG. 6: are the hinges for the lid of the case (2) Depicts the front/forward facing view with a view of the case open with the interior top foam in place and no lid. (3) is the rolling lock and clasp. (4) depicts the plastic handle.

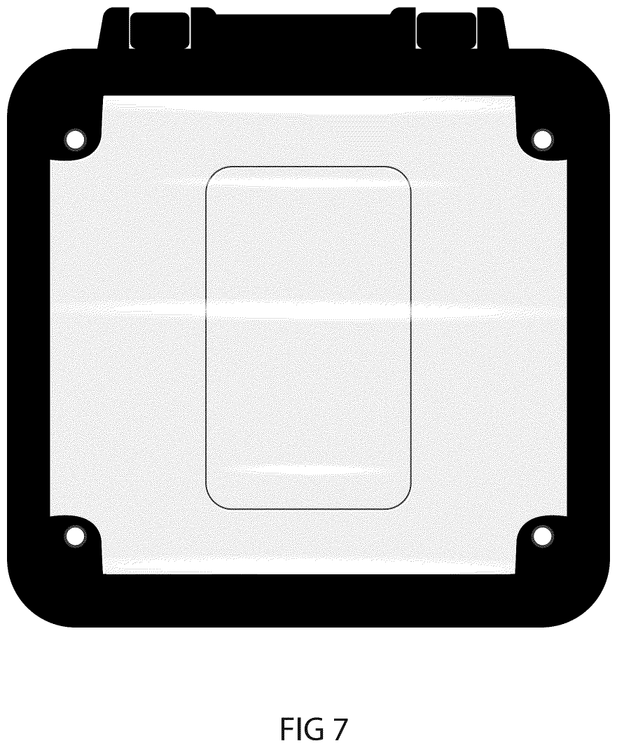

FIG. 7: From the top view down, this showcases our single row slab design with the lid closed. (1) are the hinges for the lid (2) is the acrylic window in its closed position showcasing a cut out that fits a graded card for display. (3) is the clear acrylic window for display.

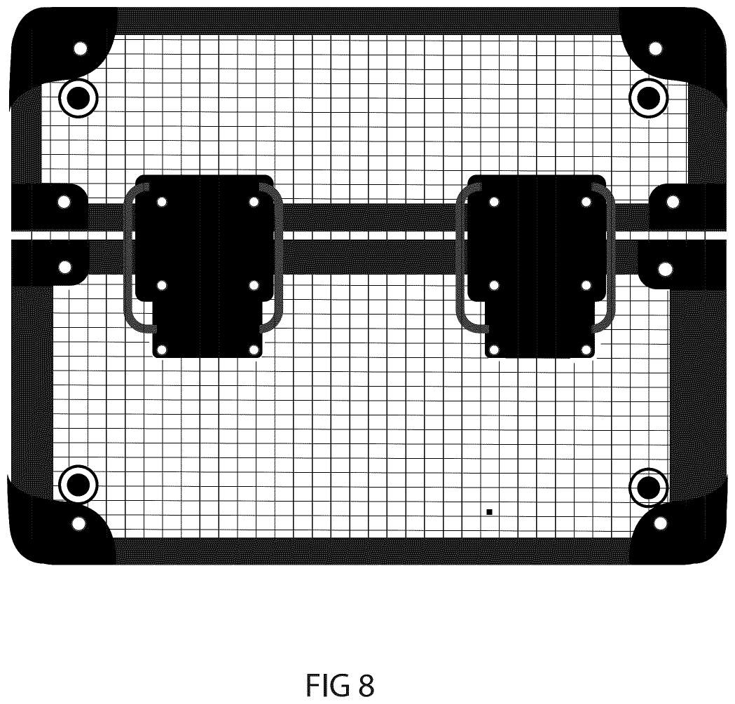

FIG. 8: Depicts the rear view of the single row slab case. (1) are the hinges for opening and closing the lid to the base (2) is the top lid and (3) is the base of the case.

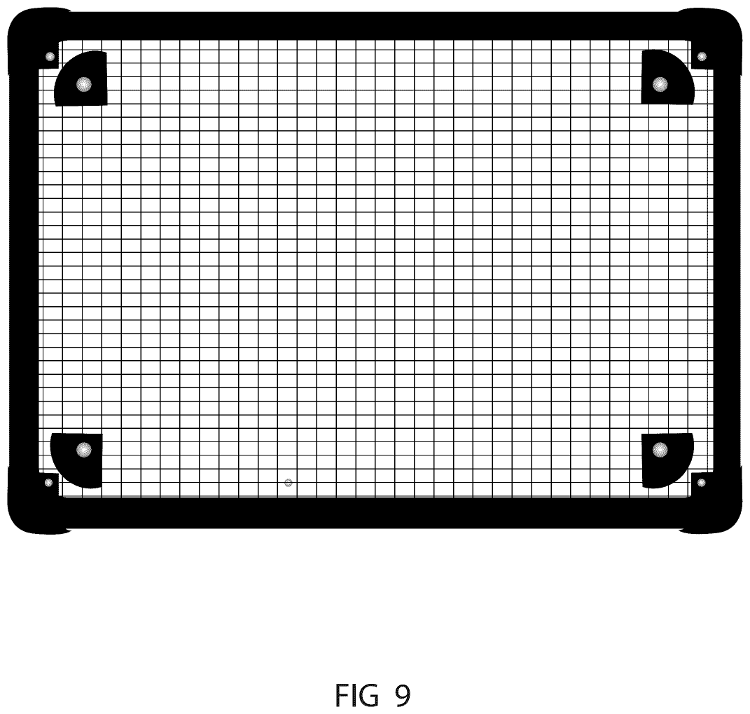

FIG. 9: Depicts the bottom of the case with a (1) solid bottom (2) with our bumpers for protecting the bottom of the case

### DETAILED DESCRIPTION OF THE INVENTION

The Party Pullz Protectorz 1 Row PSA Slab Case is a meticulously designed display case aimed at providing a high-quality solution for the presentation and protection of collectible cards, particularly those housed in PSA slabs. This case is designed with both aesthetic appeal and functional security in mind, catering to the needs of serious collectors.

Construction and Materials: The display case is primarily constructed from durable materials that ensure long-lasting use. The exterior of the case features a sleek, modern design available in a variety of color options, allowing collectors to choose a style that best matches their personal taste or existing display environment. The case's finish is not only visually appealing but also resistant to common forms of wear and tear, ensuring that the case remains in pristine condition over time.

Acrylic Window Display: One of the key features of this display case is the acrylic window, which serves as the primary viewing area for the PSA slabs. The acrylic is chosen for its clarity and strength, providing an unobstructed view of the slabs while also offering a degree of protection against dust and environmental factors. The window is designed to showcase the slabs prominently, allowing for an engaging display that highlights the details and grades of the collectible cards.

Reinforced Foam Inserts: Inside the case, the slabs are securely held in place by reinforced foam inserts. These inserts are custom-designed to fit PSA slabs snugly, preventing movement that could lead to scratches or other damage. The foam material is both dense and soft, providing cushioning that absorbs impacts while cradling the slabs. This ensures that the valuable contents are protected against physical shocks, which is crucial for maintaining their condition and value.

Security Features: To further protect the collectibles, the display case is equipped with programmable rolling locks. These locks allow the user to set a custom code, which must be entered to open the case. This feature provides a significant level of security, preventing unauthorized access and giving collectors peace of mind that their valuable items are safe.

Versatility and Customization: The Party Pullz Protectorz 1 Row PSA Slab Case is designed to accommodate not only PSA slabs but also slabs from other grading companies, such as SGC and Beckett. The foam inserts can be adjusted or replaced to fit different slab sizes if needed, adding to the case's versatility. Additionally, the case's customizable exterior color options allow collectors to personalize their display, making it a versatile addition to any collection.

Target Audience: This display case is ideal for both professional and enthusiast collectors. Professional collectors, who often have extensive and valuable collections, will appreciate the case's security features and the high-quality display it provides. Enthusiast collectors, who may have smaller but equally cherished collections, will find the case an attractive and practical solution for showcasing their most prized items.

The Party Pullz Protectorz 1 Row PSA Slab Case is a versatile and secure display case designed to hold up to 75 collectible card slabs, including PSA, SGC, and Beckett slabs. It features a clear acrylic window for prominently showcasing three slabs, reinforced foam inserts for protection, and programmable rolling locks for added security. Available in various colors, the case combines stylish design with practical functionality, making it ideal for both professional and enthusiast collectors.

### Problem Solved

The Party Pullz Protectorz 1 Row PSA Slab Case addresses several critical issues faced by collectors of valuable graded cards. Traditional storage solutions often fall short in two main areas: protection and display. Common methods like generic boxes or standard display cases may not provide adequate security or fail to enhance the visual appeal of the collectibles. This invention solves these problems by integrating both superior protection and an attractive presentation into one product.

Enhanced Protection: The reinforced foam inserts within the case offer superior cushioning and support, which prevents physical damage such as scratches, dents, and impacts. This is crucial for preserving the condition of collectible slabs, which can be highly sensitive to environmental conditions and physical handling. The foam also helps shield the slabs from dust, moisture, and UV light, further safeguarding their value and integrity.

Aesthetic Display: Unlike traditional storage solutions that prioritize function over form, this case combines practical protection with an eye-catching display. The acrylic window allows for a clear, unobstructed view of the slabs, making it easy for collectors to showcase their prized items prominently. This design ensures that the slabs are not only safe but also presented in a manner that highlights their importance and quality.

### Solution & Usage

The Party Pullz Protectorz 1 Row PSA Slab Case offers a comprehensive solution for collectors who need both an elegant display and robust protection for their valuable card slabs.

Stylish Presentation: The case features a sleek, modern design and is available in various colors to suit different aesthetic preferences. The clear acrylic window prominently displays the collectible slabs, allowing collectors to highlight their most valuable or cherished items. This design choice makes the case suitable for high-profile display settings, such as in a home gallery, office, or at collectible shows.

Secure Storage: Beyond aesthetics, the case is designed with practical security features. The programmable rolling locks provide an added layer of protection against unauthorized access, ensuring that the slabs remain secure. This is particularly important for collectors who want to safeguard their investments from potential theft or tampering.

Ease of Use: The case is user-friendly, allowing collectors to insert and remove slabs while maintaining security easily. The combination of visual appeal and practical functionality makes it an ideal solution for private collectors and those participating in public displays or exhibitions.

In summary, the Party Pullz Protectorz 1 Row PSA Slab Case addresses the dual needs of secure storage and attractive presentation. It provides a sophisticated and functional solution that enhances the display of valuable collectible slabs while ensuring their protection and preservation.

### Similar Inventions

There are existing products in the market that serve a similar function to the Party Pullz Protectorz 1 Row PSA Slab Case, such as the Display Vault Card Edition. These products are designed to store and display collectible cards but differ in several key aspects:

Shape and Design: Many existing display cases, including the Display Vault Card Edition, feature a rectangular or multi-row design. This differs from the Party Pullz Protectorz case, which utilizes a one-row, square design that sets it apart in terms of both aesthetics and functionality.

Capacity: While some display cases can hold multiple rows of slabs, the Party Pullz Protectorz case focuses on a single row, allowing for a streamlined display of up to 75 slabs. This single-row configuration provides a more focused and elegant presentation of the collectible items.

Weight and Build: The Party Pullz Protectorz case is designed to be lightweight, which enhances its portability and ease of handling. This contrasts with some existing cases that may be heavier due to their multi-row design and additional features.

Comparison & Improvements: The Party Pullz Protectorz 1 Row PSA Slab Case introduces several improvements and unique features compared to existing display cases:

One-Row Configuration: The introduction of a one-row display design offers a more focused and visually striking presentation. This configuration allows collectors to showcase a select number of prized slabs prominently, without the clutter of multiple rows. It also simplifies the organization of the display, making it easier to highlight individual items.

Square Shape: The square shape of the Party Pullz Protectorz case provides a modern and aesthetically pleasing alternative to traditional rectangular cases. This shape not only enhances the visual appeal but also allows for more versatile placement and integration into various display settings.

Lightweight Design: The lightweight nature of the case offers significant advantages in terms of portability and ease of handling. Collectors can move or transport the case with greater convenience, which is particularly beneficial for those who attend collectible shows or wish to rearrange their displays frequently.

Enhanced Protection and Security: In addition to its design features, the Party Pullz Protectorz case includes reinforced foam inserts and programmable rolling locks, which provide superior protection and security compared to some existing solutions. This ensures that the collectible slabs are well-protected against damage and unauthorized access.

The Party Pullz Protectorz 1 Row PSA Slab Case represents a significant advancement in the display and protection of collectible cards. This innovative case features a sleek, square design with a single-row configuration, setting it apart from traditional multi-row and rectangular display options. Its clear acrylic window allows for a prominent and attractive showcase of up to 75 collectible slabs, including PSA, SGC, and Beckett cards.

The case combines aesthetic appeal with practical functionality by incorporating reinforced foam inserts that provide superior protection against physical damage and environmental factors. Additionally, the inclusion of programmable rolling locks enhances security, ensuring that the collectibles are safeguarded from unauthorized access.

Overall, the Party Pullz Protectorz 1 Row PSA Slab Case fills a notable gap in the market by offering a stylish, lightweight, and secure solution for collectors. Its unique design and advanced features address common shortcomings of existing products, making it a valuable addition to any collection display setup.

1. A display case for collectible card slabs, comprising:
A housing unit configured to hold and display up to 75 card slabs;
An acrylic window integrated into the housing unit, providing a clear view of up to three slabs displayed prominently;
Reinforced foam inserts within the housing unit, designed to securely hold the card slabs and protect them from physical damage, dust, moisture, and UV light;
Programmable rolling locks for securing the case, allowing a custom code to be set for preventing unauthorized access.

2. The display case of claim 1, wherein the housing unit is designed in a square shape to provide an aesthetically pleasing and modern display option.

3. The display case of claim 1, wherein the acrylic window is positioned to allow for unobstructed visibility of the card slabs, enhancing the presentation of the displayed items.

4. The display case of claim 1, wherein the reinforced foam inserts are custom-designed to fit various types of card slabs, including PSA, SGC, and Beckett slabs.

5. The display case of claim 1, wherein the programmable rolling locks are configured to allow the user to set and change a custom combination code for added security.

6. The display case of claim 1, wherein the housing unit is available in various colors, providing options for customization to suit different aesthetic preferences.
